(19) United States
(12) Patent Application Publication
(10) Pub. No.: US 2026/0270937 A1
(43) Pub. Date: Sep. 10, 2026

(54) INTEGRATED PROCEDURE FOR USER EQUIPMENT (UE) CAPABILITY EXPOSURE AND POSITIONING SERVER UE SELECTION

(71) Applicant: MEDIATEK INC., Hsinchu City (TW)

(72) Inventor: Nathan Edward TENNY, San Jose, CA (US)

(21) Appl. No.: 19/166,276

(22) PCT Filed: Jun. 17, 2024
(86) PCT No.: PCT/CN2024/099538

§ 371 Date: Sep. 17, 2025

Related U.S. Application Data
(60) Provisional application No. 63/510,640, filed on Jun. 28, 2023.

(51) Int. Cl. H04W 64/00; H04W 92/18

(52) U.S. Cl. CPC H04W 64/00; H04W 92/18

(57) ABSTRACT

Various techniques pertaining to an integrated procedure for user equipment (UE) capability exposure and positioning server UE selection in sidelink communications are described. A first UE, as a target UE, discovers one or more UEs including the second UE via a first sidelink procedure. The first UE also receives capability information of the one or more UEs (including capability information of the second UE) via a second sidelink procedure. The first UE then discovers and, optionally, selects the second UE as a positioning server UE based on the capability information.

### CROSS REFERENCE TO RELATED PATENT APPLICATION

The present disclosure is part of a non-provisional patent application claiming the priority benefit of U.S. Provisional Patent Application No. 63/510,640, filed 28 Jun. 2023, the content of which herein being incorporated by reference in its entirety.

### TECHNICAL FIELD

The present disclosure is generally related to wireless communications and, more particularly, to an integrated procedure for user equipment (UE) capability exposure and positioning server UE selection in sidelink communications.

### BACKGROUND

Unless otherwise indicated herein, approaches described in this section are not prior art to the claims listed below and are not admitted as prior art by inclusion in this section.

In a wireless communication environment, such as mobile communications under one or more 3^{rd} Generation Partnership Project (3GPP) standards, mobile devices such as user equipments (UEs) may be engaged in device-to-device communication, with or without the involvement of a serving wireless network. For example, the UEs may communicate over a sidelink interface, also known as a PC5 interface. In some situations, positioning of one or more of the UEs, referred to as “target UEs”, may be required, and sidelink positioning techniques may be available for meeting this requirement, based, for example, on transmission of sidelink positioning reference signals (SL-PRS) between the target UE(s) and one or more peer UEs, which may be referred to as “anchor UEs”. An anchor UE may also be referred to as a “reference UE”, or, in case its location is known, a “located UE”. In some cases, an anchor UE may also have the functionality of a “positioning server UE”, as described below.

In some cases of sidelink positioning, one UE in a group of involved UEs may have a distinguished role as a “positioning server UE” (which may be referred to simply as a “server UE”). The server UE may be responsible for any or all of several functions including calculating a location estimate, configuring SL-PRS transmissions between the target UE(s) and the anchor UE(s), determining whether an obtained location estimate meets quality of service (QoS) requirements, selecting which anchor UEs are to be used in a positioning operation, distributing assistance data, and so on. The server UE may be selected by a target UE. In some cases, the server UE may be the same as the target UE or as one of the anchor UEs.

To support communication and/or positioning on the sidelink, the involved UEs may perform a discovery procedure to detect and identify one another. In one example, which may be referred to as “Model A” discovery, a first UE sends an announcement message (sometimes described as an “I am here” message) to indicate that it is available for a sidelink communication, and a second UE receives the announcement message and determines whether to initiate communication with the first UE. In another example, which may be referred to as “Model B” discovery, a first UE sends a solicitation message (sometimes described as a “Who is there?” message) to request peers for communication on a sidelink, and a second UE receives the solicitation message and sends a response message to the first UE to indicate that it is available for sidelink communication. After the discovery messages have been exchanged, the UEs may exchange additional messages to initiate communication for a sidelink service.

For sidelink positioning operation, each UE may support a certain set of capabilities, which may be signaled to other UEs to allow compatible operation of the multiple UEs involved in a sidelink positioning procedure. As one example, a UE's capabilities may include the ability to support certain positioning methods in certain roles (e.g., support of timing-based sidelink positioning as an anchor UE, support of angle-based sidelink positioning as a server UE, and so on). The selection of UEs to function in certain roles may depend on these capabilities, and in particular, it may be necessary for the server UE to be aware of the capabilities of potential anchor UEs in order to select anchor UEs that can support a desired sidelink positioning operation. Similarly, it may be important for the target UE to know the capabilities of a potential server UE, so that the target UE can select a server UE that meets the requirements of a requested sidelink positioning operation. For performance reasons and to reduce overhead on the sidelink interface, it is desirable to distribute these UE capabilities with an efficient signaling procedure, at the same time that the server UE is selected and the anchor UEs are marshalled (for instance, by the server UE) to support sidelink positioning.

Therefore, there is a need for a solution that is directed to the exchange of UE capabilities, particularly related to sidelink positioning, among the target UE(s), the anchor UE(s), and the server UE, in a manner integrated into a procedure for selecting the server UE.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to an integrated procedure for UE capability exposure and positioning server UE selection in sidelink communications.

In one aspect, a method may involve a processor of a first UE discovering one or more UEs, including a second UE, via a first sidelink procedure. The method may also involve the processor receiving capability information of the one or more UEs (including capability information of the second UE) via a second sidelink procedure. The method may further involve the processor discovering and, optionally, selecting the second UE as a positioning server UE based on the capability information.

In another aspect, a method may involve a processor of a second UE performing a discovery procedure with a first UE via a first sidelink procedure. The method may also involve the processor sending capability information to the first UE via a second sidelink procedure. The method may further involve the processor receiving a selection message from the first UE via a third sidelink procedure indicating selection of the second UE as a positioning server UE.

In yet another aspect, an apparatus implementable in a first UE may include a transceiver configured to communicate wirelessly and a processor coupled to the transceiver. The processor may discover one or more UEs, including a second UE, via a first sidelink procedure. The processor may also receive capability information of the one or more UEs via a second sidelink procedure. The processor may then discover and, optionally, select the second UE as a positioning server UE based on the capability information.

It is noteworthy that, although description provided herein may be in the context of certain radio access technologies, networks and network topologies such as, 5^{th} Generation (5G)/New Radio (NR), the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Industrial IoT (IIoT), narrowband IoT (NB-IoT), Wi-Fi (or WiFi), Bluetooth and ZigBee. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram illustrating an example of sidelink positioning.

FIG. 2 is a flow diagram illustrating a set of steps of a sidelink positioning procedure.

FIG. 3 is a flow diagram illustrating an example of a capability exchange between a target UE and one or more anchor UEs.

FIG. 4 illustrates an example of discovery and selection between a target UE and a server UE, in accordance with an embodiment of this invention.

FIG. 5 is a flow diagram illustrating an example of a capability exchange procedure between a target UE and a server UE, in accordance with an embodiment of this invention.

FIG. 6 is a flow diagram illustrating an example of server UE selection by a target UE, in accordance with an embodiment of this invention.

FIG. 7 is a flow diagram illustrating an example of discovery and capability exchange between a server UE and a set of anchor UEs, in accordance with an embodiment of this invention.

FIG. 8 is a flow diagram illustrating a positioning procedure incorporating discovery, selection, and capability exchange procedures, in accordance with an embodiment of this invention.

FIG. 9 is a block diagram of an example communication system in accordance with an implementation of the present disclosure.

FIG. 10 is a flowchart of an example process in accordance with an implementation of the present disclosure.

FIG. 11 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to an integrated procedure for UE capability exposure and positioning server UE selection in sidelink communications. According to the present disclosure, a number of possible solutions may be implemented separately or jointly. That is, although these possible solutions may be described below separately, two or more of these possible solutions may be implemented in one combination or another.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

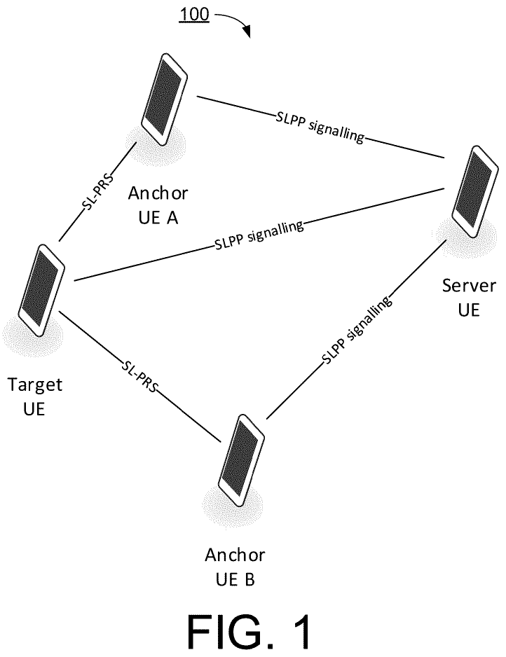

FIG. 1 illustrates an example scenario 100 with respect to a group of UEs involved in sidelink positioning under a proposed scheme in accordance with the present disclosure. The group includes a target UE, a server UE, and two anchor UEs A and B. (It should be appreciated that a sidelink positioning operation may involve substantially any number of anchor UEs. In such a case, the behavior of different anchor UEs would be expected to be consistent with the behavior shown in FIG. 1 for anchor UEs A and B.) In this example, each of the UEs pictured can communicate with any of the other UEs over a sidelink interface. Sidelink positioning reference signals (SL-PRS) may be transmitted between the target UE and anchor UEs A and B. Signaling of a positioning protocol, such as a sidelink positioning protocol (SLPP), may be exchanged between the target UE and the server UE, and/or between the anchor UEs and the server UE. In some embodiments, positioning protocol signaling (e.g., SLPP signaling) may also be exchanged between the target UE and the anchor UEs. The directions of all these transmissions and the specific functions enabled by SLPP signaling may vary according to a choice of sidelink positioning procedure(s) and method(s). For example, in a “downlink-like” or “anchor-to-target” sidelink positioning procedure, SL-PRS may be transmitted from the anchor UEs to the target UE and measured at the target UE, with the measurements subsequently being reported by the target UE to the server UE via SLPP. In this “downlink-like” case, the server UE and the anchor UEs may exchange SLPP signaling to coordinate the transmission of SL-PRS. As another example, in an “uplink-like” or “target-to-anchor” sidelink positioning procedure, SL-PRS may be transmitted from the target UE to the anchor UEs and measured at the anchor UEs, with the measurements subsequently being reported by the anchor UEs to the server UE via SLPP. In this “uplink-like” case, the target UE and the server UE may exchange SLPP signaling to coordinate the transmission of SL-PRS. In both examples, the SL-PRS measurements may, for instance, take the form of time difference of arrival (TDOA) or relative time of arrival (RTOA) measurements, angular measurements, signal strength measurements, and so on. It is noted that the “downlink-like” and “uplink-like” approaches may be combined in a single sidelink positioning operation that involves bidirectional transmission of SL-PRS between the target UE and the anchor UEs; such an operation may, for instance, represent a sidelink roundtrip time (SL-RTT) positioning method.

In short, sidelink positioning without network involvement may rely on a server UE that functions like a Location Management Function (LMF) in mobile communications under the 3GPP standards. The server UE may correspond with a target UE and anchor UEs to coordinate transmission and measurement of SL-PRS as well as computation of the target UE's location. The server UE may also compute its own location. Moreover, the server UE may correspond with other UEs with SLPP (which may be analogous to the LTE Positioning Protocol (LPP)). It is noteworthy that, although examples described herein may be provided in the context of SLPP, messages exchanged between/among the UEs are merely described functionally rather than being tied to specific SLPP message names, and some or all of the described functions may be realized by messages of a different protocol.

Under various proposed schemes in accordance with the present disclosure, an interaction between a target UE and a server UE may be performed with respect to peer UE discovery, server UE selection, and capability exchange. For instance, the target UE may discover and select one of a plurality of peer UEs as the server UE. The capability of the server UE may be announced first, followed by the server UE interrogating the target UE for its capabilities.

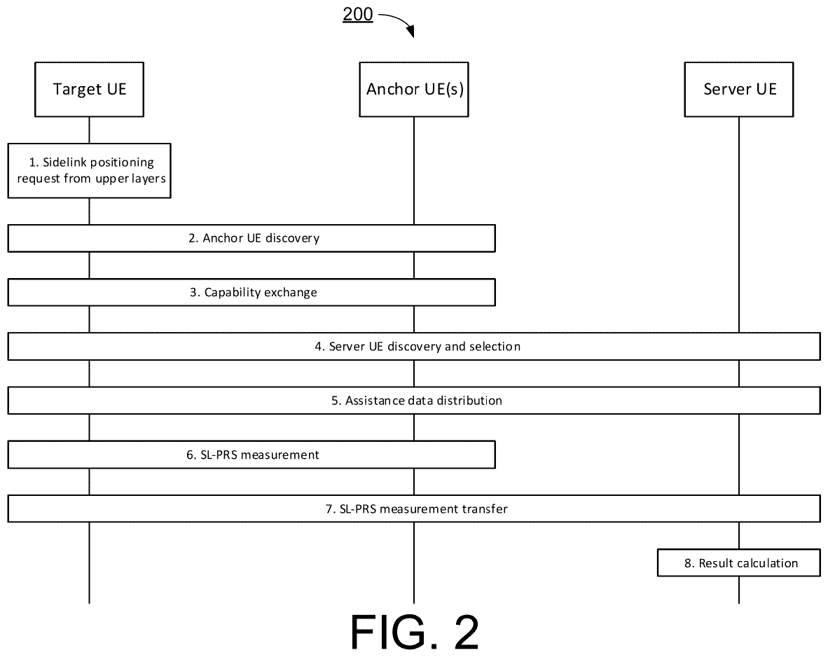

FIG. 2 illustrates an example scenario 200 with respect to an exemplary set of steps for a sidelink positioning procedure involving a target UE, one or more anchor UEs, and a server UE. In step 1 of FIG. 2, the target UE is requested by upper layers to perform a sidelink positioning procedure; this step may, for instance, be the result of the upper layers receiving a request from a client or an indication from a user that a position estimate is needed. In step 2, the target UE performs a discovery procedure with the anchor UE(s). In step 3, the target UE performs an exchange of capabilities with the anchor UE(s); in various examples, this step may comprise the target UE indicating its capabilities to the anchor UE(s), the anchor UE(s) indicating their capabilities to the target UE, or both. In step 4, the target UE performs a discovery procedure with the server UE, and the target UE selects the server UE to use for this positioning procedure. In step 5, assistance data are distributed among the target UE and the anchor UE(s); the nature of these assistance data, and the level of involvement of the server UE, will be different in different examples. For instance, in some cases, the server UE may gather assistance data (e.g., SL-PRS configurations) relating to the anchor UE(s) and forward the assistance data to the target UE; in other cases, the server UE may gather assistance data relating to the target UE and forward the assistance data to the anchor UE(s); in still other cases, the server UE may not be involved, and the target and anchor UEs may exchange assistance data autonomously; and so on. In step 6, SL-PRS are transmitted and measured between the anchor UE(s) and the target UE; as described in FIG. 1, this step may involve SL-PRS transmission in either direction (target-to-anchor or anchor-to-target) or both, and the measurements may be taken at the target UE, the anchor UE(s), or both. In step 7, results of the measurement step are transferred to the server UE from whichever UE(s) measured SL-PRS in step 6. In step 8, the server UE calculates a location estimate. It should be noted that the procedure of FIG. 2 does not provide any capabilities to or from the server UE; that is, the target UE must select the server UE without knowing the server UE's capabilities, and the server UE must perform its operations from step 5 onward without knowing the target UEs or the anchor UE(s)′ capabilities. This deficiency of the procedure may result in suboptimal choice of a server UE—for instance, one with limited support for sidelink positioning methods—and may create challenges for the server UE in the later steps of the procedure, such as needing to negotiate SL-PRS configurations with the target UE and/or the anchor UE(s) without knowing their capabilities.

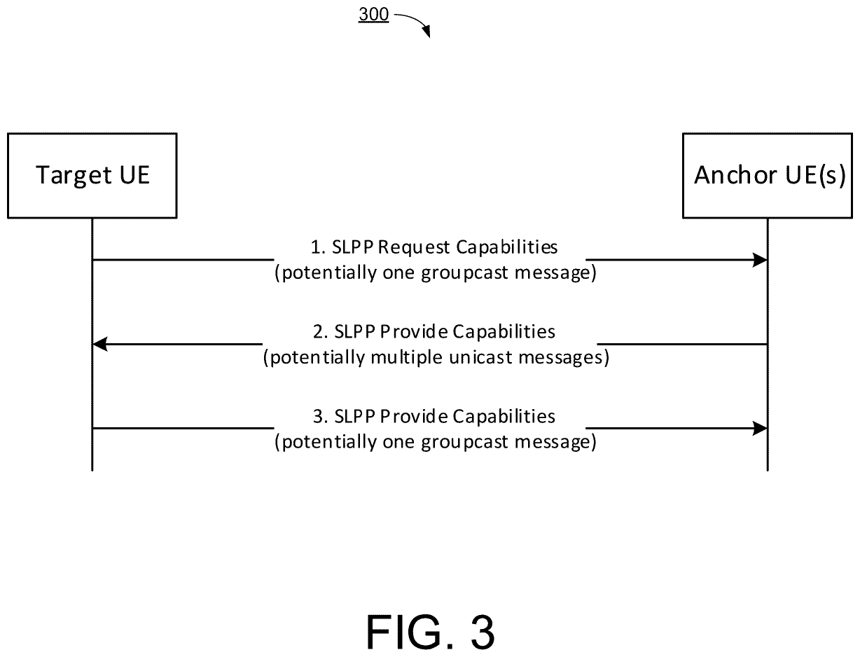

FIG. 3 illustrates an example scenario 300 with respect to an exemplary flow of messages for capability exchange between a target UE and one or more anchor UEs, which may correspond, for example, to step 3 of FIG. 2. In step 1 of FIG. 3, the target UE sends to the anchor UE(s) a capability enquiry message, such as an SLPP Request Capabilities message of an SLPP protocol. The message of step 1 may be transmitted by groupcast, i.e., a single message may be transmitted with addressing that makes it available to multiple recipients (in this case the anchor UEs); alternatively, the message of step 1 may be transmitted as multiple unicast messages, one to each recipient anchor UE. In step 2, one or more of the anchor UE(s) respond with a capability description message, such as an SLPP Provide Capabilities message of an SLPP protocol. In contrast to step 1, each anchor UE in step 2 may be expected to send its own capability information independently, as a unicast message to the target UE. In some examples, the procedure may terminate after step 2 (for example, if the anchor UEs do not need to know the capability information of the target UE). In other examples, the procedure may proceed to step 3, in which the target UE sends to the anchor UE(s) a capability description message, such as an SLPP Provide Capabilities message of an SLPP protocol. The message of step 3 may be sent as a groupcast message or as multiple unicast messages, similar to step 1. The message of step 3 may be triggered automatically by the target UE in response to receiving the capabilities of the anchor UE(s), or it may be sent in response to a request (not shown in FIG. 3). In an example, the capability information message(s) of step 2 may include an indication that the anchor UE(s) require the capabilities of the target UE. In another example, one or more anchor UE(s) may send to the target UE a capability request message (not shown), such as an SLPP Request Capabilities message of an SLPP protocol.

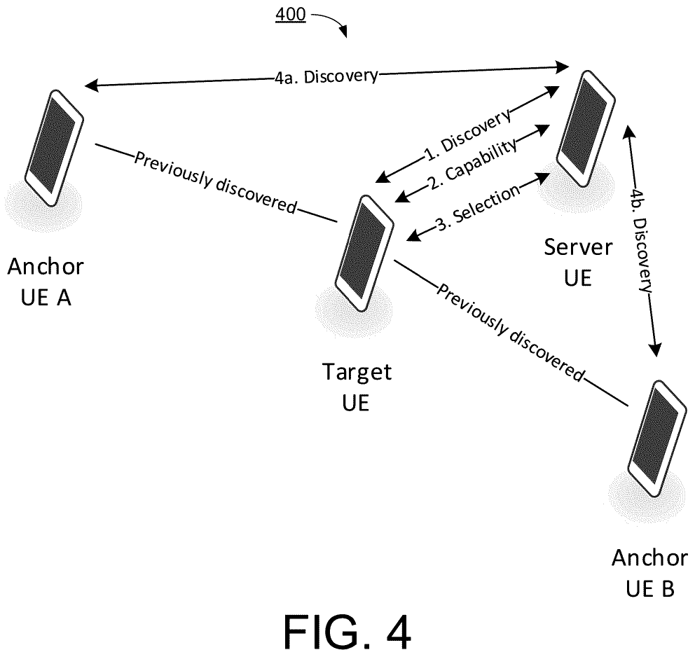

FIG. 4 illustrates an example scenario 400 with respect to discovery and selection of a server UE by a target UE, which may correspond, for example, to step 4 of FIG. 2, in accordance with an embodiment of this invention. FIG. 4 shows a target UE, a server UE, and two candidate anchor UEs A and B. (UEs A and B are referred to here as “candidate” anchor UEs because they do not function as anchor UEs until they have been selected to participate in a positioning operation.) The candidate anchor UEs are presumed to have been discovered previously by the target UE, so that the target UE is aware of the availability of UEs A and B and their ability to function as anchor UEs. In step 1 of FIG. 4, the target UE and the server UE perform a discovery procedure. The discovery procedure may be in accordance with either model A or model B discovery, as described previously; for example, the server UE may initiate a model A discovery procedure by advertising its availability as a server UE and the target UE may determine whether to initiate communication and proceed to the subsequent steps of the procedure, or the target UE may initiate a model B discovery procedure by transmitting a solicitation for a server UE and the server UE may respond with an indication of its availability. In step 2, the target UE and the server UE perform an exchange of capability information, which may comprise the target UE indicating its capabilities to the server UE, the server UE indicating its capabilities to the target UE, or both. The details of this step are further discussed below. In step 3, the target UE and the server UE perform a server UE selection procedure, which may, for instance, comprise an exchange of messages of a positioning protocol such as SLPP. In an example, the target UE may indicate its selection of the server UE to the server UE in a first message, and the server UE may confirm that it accepts the selection in a second message. In some cases, the second message may be omitted. The first message may include additional information such as the identities of one or more candidate anchor UEs; the identities may be provided in various formats, such as a layer 2 ID (L2ID), a radio network temporary identifier (RNTI), and the like. (The term “RNTI” is general to a number of identifiers used in the radio layers of the system, including, for example, a cell RNTI or C-RNTI, an inactive RNTI or I-RNTI, and so on.) In steps 4a and 4b, the server UE may perform a discovery procedure with candidate anchor UEs A and B, respectively; this discovery procedure may be carried out according to either model A or model B, but in the context of this procedure, it may be preferred to follow model B, with the server UE soliciting responses from the candidate anchor UEs, since the server UE naturally knows when the discovery step should begin based on the completion of the selection process in step 3. In a subsequent positioning procedure, the results of the discovery procedure in steps 4a/4b may affect the selection of anchor UEs, for example, by limiting the selected anchor UEs to those that can communicate with both the target UE and the server UE.

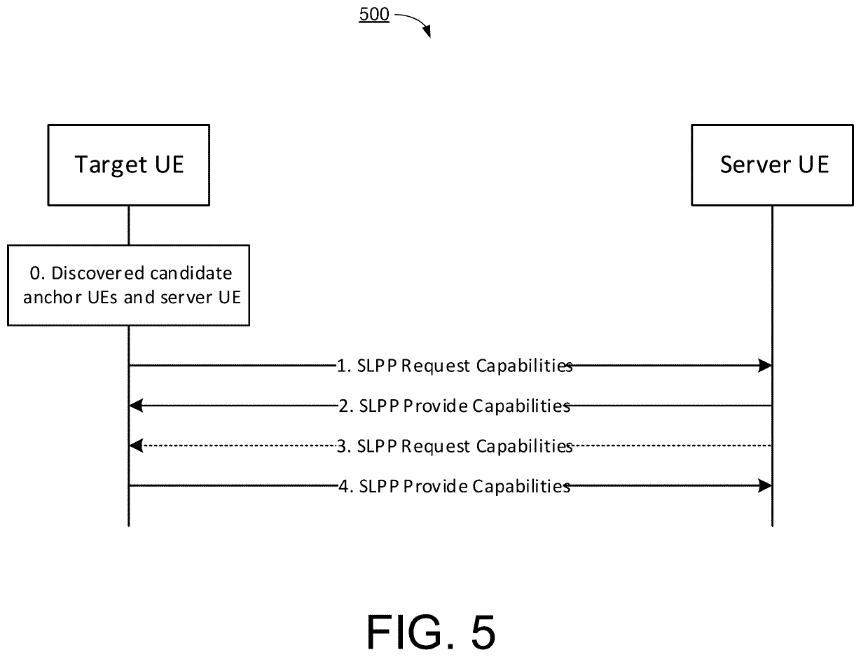

FIG. 5 illustrates an example scenario 500 with respect to a potential series of steps comprising step 2 of FIG. 4, the exchange of capabilities between the target UE and the server UE, in accordance with an embodiment of this invention. Step 0 of FIG. 5 represents a precondition that discovery has occurred between the target UE and one or more candidate anchor UEs. The objective of the procedure in FIG. 5 is to establish sufficient knowledge of capabilities between the target and the server UEs to support server UE selection. This knowledge may be in either direction or both; that is, the target UE may need to know the server UE's capabilities, the server UE may need to know the target UE's capabilities, or both. Accordingly, the arrows shown in FIG. 5 represent a particular order of messages, but other orderings are conceivable. In step 1 of FIG. 5, the target UE sends to the server UE a first capability request message, such as an SLPP Request Capabilities message. In some embodiments, step 1 may also include reporting of the capabilities of the target UE to the server UE, for example, in an accompanying capability information message such as an SLPP Provide Capabilities message or in a field of the first capability request message. In step 2, the server UE sends to the target UE a first capability information message, such as an SLPP Provide Capabilities message. In some embodiments, step 2 may also comprise a request for the capabilities of the target UE, for instance, in the form of a Boolean flag in the first capability information message to indicate that the server requests the capabilities of the target. In step 3, which is shown as an optional step (dashed arrow) in FIG. 5, the server UE may send to the target UE a second capability request message; step 3 may, for instance, be necessary in case step 2 did not include a request for the capabilities of the target UE. In step 4, which may, for example, be responsive to a request for the capabilities of the target UE from step 2 or to the second capability request message from step 3, the target UE sends to the server UE a second capability information message, such as an SLPP Provide Capabilities message.

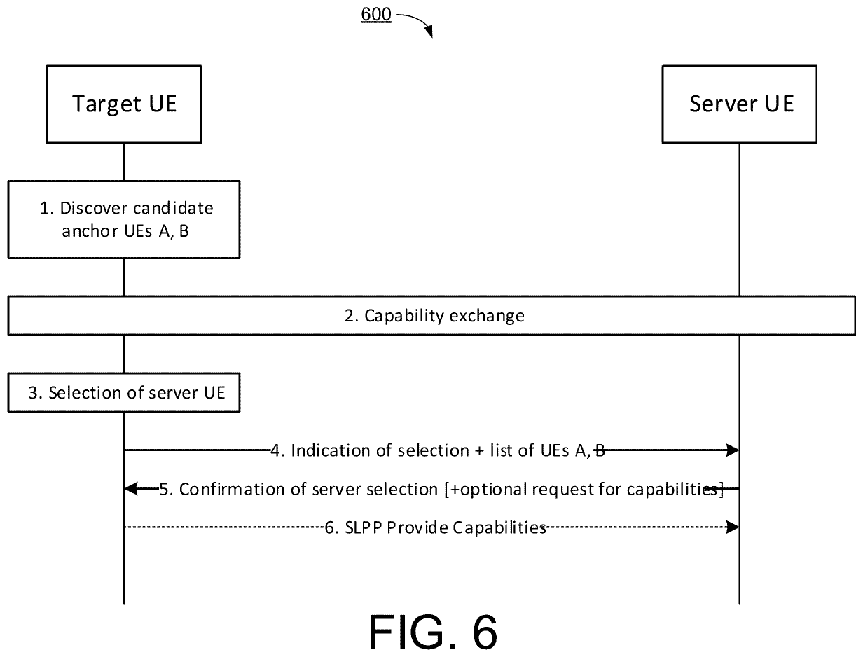

FIG. 6 illustrates an example scenario 600 with respect to an exemplary procedure for selection of a server UE and delivery to the server UE of a list of candidate anchor UEs, in accordance with an embodiment of this invention. Steps 1 and 2 represent preconditions for the procedure. In step 1, the target UE discovers candidate anchor UEs A and B (which are not shown in FIG. 6). In step 2, the target UE and the server UE perform a capability exchange procedure, which may, for example, resemble the procedure of FIG. 5. In step 3, the target UE determines that it will select this server UE; this step may take into account, for example, the capabilities of the server UE as indicated in step 2, the requirements of a location request that motivates the server selection procedure, and so on. The exact selection criteria applied by the target UE in step 3 may be determined by the target UE implementation. In step 4, the target UE sends to the server UE a server selection message, which may, for example, be a message of an SLPP protocol. The server selection message may also include the identities of the previously discovered candidate anchor UEs A and B; alternatively, these identities may be indicated to the server UE in a separate message. As one example, step 4 of FIG. 6 may be replaced by two messages, such as an SLPP Server Selection message and an SLPP Anchor UE Identification message. In step 5, the server UE sends to the target UE a selection confirmation message, which may be a message of an SLPP protocol. The selection confirmation message may comprise a request for the capabilities of the target UE, such as a Boolean flag indicating that the server UE requests the capabilities of the target UE. Such a request for the capabilities of the target UE may be useful, for instance, in case the capability exchange in step 2 does not include delivery of the capabilities of the target UE to the server UE. In step 6, which is shown as optional (dashed arrow) in FIG. 6, the target UE sends to the server UE a capability information message, such as an SLPP Provide Capabilities message. Step 6 may occur in case step 5 included a request for the capabilities of the target UE.

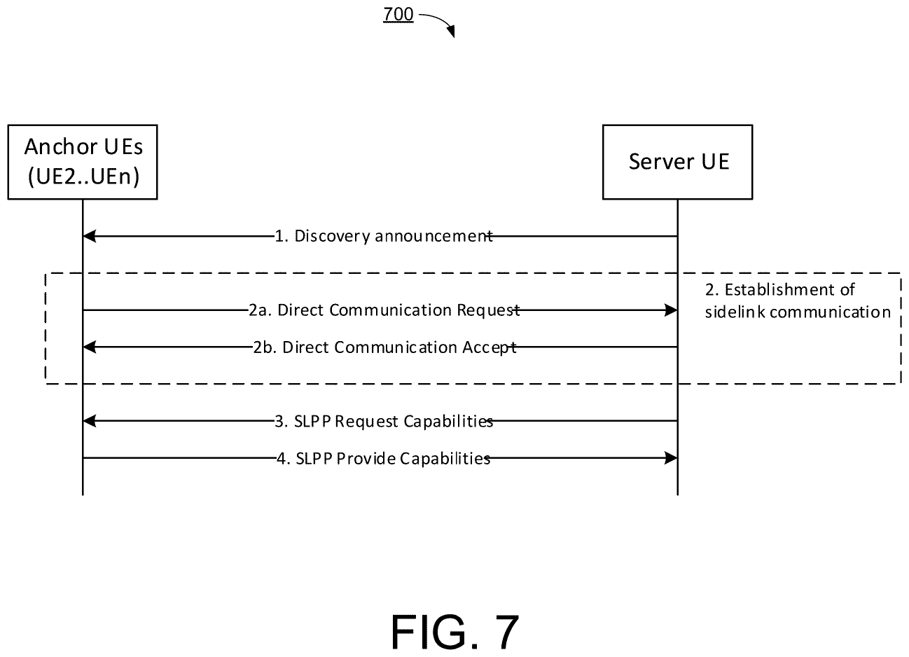

FIG. 7 illustrates an example scenario 700 with respect to an exemplary procedure for the discovery and selection of anchor UEs by a server UE, which may take place, for example, subsequent to a server UE selection procedure similar to FIG. 6, in accordance with an embodiment of this invention. In steps 1 and 2, the server UE and a set of candidate anchor UEs perform discovery and establish sidelink communication; for example, these steps may proceed, as shown in FIG. 7, via a discovery announcement by the server UE (step 1), followed by an establishment of sidelink communication comprising a Direct Communication Request message sent from each candidate anchor UE that received the discovery announcement (step 2a) and a corresponding Direct Communication Accept message sent from the server UE to the corresponding candidate anchor UE (step 2b). As an alternative not shown in FIG. 7, these steps may proceed via a discovery solicitation message from one or more of the candidate anchor UEs, followed by a discovery response from the server UE and an establishment of sidelink communication. In step 3, the server UE sends to one or more of the candidate anchor UEs a capability request message, such as an SLPP Request Capabilities message. The capability request message may, for example, be sent by groupcast to all the candidate anchor UEs with which the server UE was able to establish communication in step 2; alternatively, the server UE may send individual unicast capability request messages to the individual candidate anchor UEs. In step 4, each of the one or more of the candidate anchor UEs may send to the target UE a capability information message, such as an SLPP Provide Capabilities message.

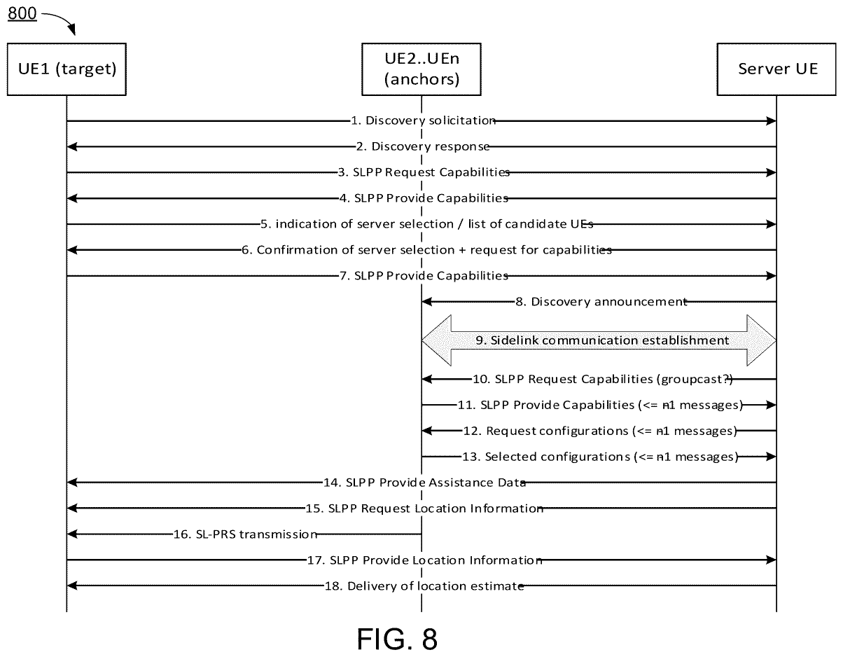

FIG. 8 illustrates an example scenario 800 with respect to an exemplary positioning procedure that incorporates discovery, selection, and capability exchange procedures in accordance with an embodiment of this invention. This flow may be seen as a unification of the procedures previously described, combined with the framework of a positioning operation. Before the flow starts, the target UE is presumed to have discovered the candidate anchor UEs, such as UE2~UEn. In step 1 of FIG. 8, the target UE sends to the server UE a discovery solicitation message, which may be understood as an indication that the target UE has triggered a positioning operation and needs a server UE. The discovery solicitation message may be sent in a broadcast mode, for example, enabling it to be received by any candidate server UE within communication range of the target UE. In step 2, the candidate server UE sends to the target UE a discovery response message, indicating that it received the discovery solicitation message and is available to operate as a server UE. In step 3, the target UE sends to the candidate server UE a first capability request message, such as an SLPP Request Capabilities message. In step 4, the candidate server UE sends to the target UE a first capability information message, such as an SLPP Provide Capabilities message. In step 5, the target UE sends to the candidate server UE an indication that it has selected it as a server UE, accompanied by a list of the candidate anchor UEs, such as UE2~UEn. In step 6, the server UE (now no longer a “candidate”) sends to the target UE a confirmation that it accepts the selection as a server UE, accompanied by a request for the capabilities of the target UE. Alternatively, step 6 may comprise only the confirmation, and the server UE may send to the target UE, after step 6, a second capability request message, such as an SLPP Request Capabilities message. In step 7, the target UE sends to the server UE a second capability information message, such as an SLPP Provide Capabilities message. In step 8, the server UE sends to the candidate anchor UEs a discovery announcement message; this message may be sent in a groupcast mode, for example. The message of step 8 may not be received by all of the candidate anchor UEs; for instance, some candidate anchor UEs that were discovered by the target UE may not be within radio communication range of the server UE. In step 9, the server UE and a subset of the candidate anchor UEs (for example, the candidate anchor UEs that received the discovery announcement in step 8) establish sidelink communication (for example, by exchanging Direct Communication Request and Direct Communication Accept messages as described previously). In step 10, the server UE sends to one or more of the candidate anchor UEs (for example, the candidate anchor UEs with which sidelink communication was established in step 9) a third capability request message, such as an SLPP Request Capabilities message; this message may be sent in a groupcast mode, for example. In step 11, a subset of the candidate anchor UEs (for example, the candidate anchor UEs with which sidelink communication was established in step 9, or the candidate anchor UEs that received the third capability request message in step 10) send to the server UE a third capability information message, such as an SLPP Provide Capabilities message. It is noted that the messages of step 11 would typically be sent individually, in a unicast mode, and the step as a whole comprises at most (n-1) messages, one from each of the candidate UEs.

After step 11, the selection and capability exchange procedure may be considered complete, and the following steps carry out an exemplary positioning procedure; the example shown in FIG. 8 may be described as a “downlink-like” or “anchor-to-target” positioning procedure, in which the anchor UEs transmit SL-PRS and the target UE measures them, and alternative procedures are possible for “uplink-like” or “target-to-anchor” positioning or for bidirectional positioning procedures, for example. Steps 12 through 18 should be understood as one possible positioning operation that follows the selection and capability exchange procedures. In step 12, the server UE sends to the anchor UEs (that is, to the subset of the candidate anchor UEs that the server UE has selected to function as anchor UEs) a configuration request message, such as a message of an SLPP protocol (various message types may be considered). In step 13, the anchor UEs send to the server UE a configuration response message, such as a message of an SLPP protocol, indicating what SL-PRS configuration they will transmit. In some cases, only a subset of the anchor UEs may accept the configuration request and respond with a selected configuration; that is, one or more of the anchor UEs may not respond at all or may indicate a rejection of the request, if, for instance, they are unable or unwilling to provide a reference signal configuration that meets the needs of the positioning operation. In step 14, the server UE sends to the target UE an assistance data message, such as an SLPP Provide Assistance Data message; this message may, for instance, contain information about the reference signal configurations determined in steps 12 and 13. In step 15, the server UE sends to the target UE a location information request message, such as an SLPP Request Location Information message. In step 16, the anchor UEs transmit SL-PRS and the target UE measures the transmitted SL-PRS. In step 17, the target UE sends to the server UE a location information message, such as an SLPP Provide Location Information message, comprising measurement results from step 16. In step 18, the server UE computes a location estimate based at least in part on the measurement results and sends the location estimate to the target UE.

In summary, in the multi-step procedure of scenario 800, a target UE may discover a server UE, with the server UE announcing (e.g., transmitting an indication) its capability to serve as a positioning server UE. The target UE may retrieve information on the server UE's capabilities. Moreover, the target UE may inform the server UE that it has been selected by the target UE as a server UE. Correspondingly, the server UE may retrieve information on the target UE's capabilities at this stage. The target UE may also provide identities of candidate anchor UEs. Accordingly, the server UE may discover one or more of the candidate anchor UEs, and the server UE may retrieve information on the capabilities of the discovered candidate anchor UE(s). Based on the retrieved information, the server UE may down-select one or more of the candidate anchor UEs. Then, the server UE may coordinate sidelink positioning among the target UE and one or more selected anchor UEs according to various existing techniques.

### Illustrative Implementations

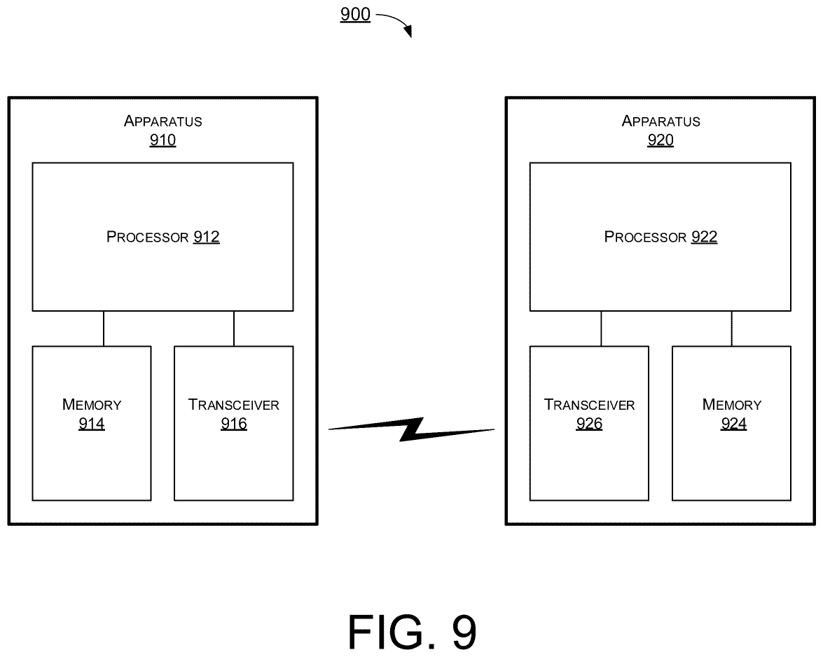

FIG. 9 illustrates an example system 900 having at least an example apparatus 910 and an example apparatus 920 in accordance with an implementation of the present disclosure. Each of apparatus 910 and apparatus 920 may perform various functions to implement schemes, techniques, processes and methods described herein pertaining to an integrated procedure for UE capability exposure and positioning server UE selection in sidelink communications, including the various schemes described above with respect to various proposed designs, concepts, schemes, systems and methods described above as well as processes described below. For instance, apparatus 910 may be implemented in or as a target UE and apparatus 920 may be implemented in or as an anchor UE or positioning server UE, or vice versa.

Each of apparatus 910 and apparatus 920 may be a part of an electronic apparatus, which may be a target UE or anchor UE/positioning server UE, such as a portable or mobile apparatus, a wearable apparatus, a wireless communication apparatus or a computing apparatus. When implemented in a UE, each of apparatus 910 and apparatus 920 may be implemented in a vehicle, a transportation tool, a smartphone, a smart watch, a personal digital assistant, a digital camera, or a computing equipment such as a tablet computer, a laptop computer or a notebook computer. Alternatively, each of apparatus 910 and apparatus 920 may also be a part of a machine type apparatus, which may be an IoT apparatus such as an immobile or a stationary apparatus, a home apparatus, a wire communication apparatus or a computing apparatus. For instance, each of apparatus 910 and apparatus 920 may be implemented in a smart thermostat, a smart fridge, a smart door lock, a wireless speaker or a home control center.

In some implementations, each of apparatus 910 and apparatus 920 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 910 and apparatus 920 may be implemented in or as a target UE or an anchor UE/positioning server UE. Each of apparatus 910 and apparatus 920 may include at least some of those components shown in FIG. 9 such as a processor 912 and a processor 922, respectively, for example. Each of apparatus 910 and apparatus 920 may further include one or more other components not pertinent to the proposed scheme of the present disclosure (e.g., internal power supply, display device and/or user interface device), and, thus, such component(s) of apparatus 910 and apparatus 920 are neither shown in FIG. 9 nor described below in the interest of simplicity and brevity.

In one aspect, each of processor 912 and processor 922 may be implemented in the form of one or more single-core processors, one or more multi-core processors, one or more RISC processors or one or more CISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed for an integrated procedure for UE capability exposure and positioning server UE selection in sidelink communications in accordance with various implementations of the present disclosure.

In some implementations, apparatus 910 may also include a transceiver 916 coupled to processor 912. Transceiver 916 may include a transmitter capable of wirelessly transmitting and a receiver capable of wirelessly receiving data. In some implementations, apparatus 920 may also include a transceiver 926 coupled to processor 922. Transceiver 926 may include a transmitter capable of wirelessly transmitting and a receiver capable of wirelessly receiving data. It is noteworthy that, although transceiver 916 and transceiver 926 are illustrated as being external to and separate from processor 912 and processor 922, respectively, in some implementations, transceiver 916 may be an integral part of processor 912 as a system on chip (SoC), and transceiver 926 may be an integral part of processor 922 as a SoC.

In some implementations, apparatus 910 may further include a memory 914 coupled to processor 912 and capable of being accessed by processor 912 and storing data therein. In some implementations, apparatus 920 may further include a memory 924 coupled to processor 922 and capable of being accessed by processor 922 and storing data therein. Each of memory 914 and memory 924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 914 and memory 924 may include a type of read-only memory (ROM) such as mask ROM, programmable ROM (PROM), erasable programmable ROM (EPROM) and/or electrically erasable programmable ROM (EEPROM). Alternatively, or additionally, each of memory 914 and memory 924 may include a type of non-volatile random-access memory (NVRAM) such as flash memory, solid-state memory, ferroelectric RAM (FeRAM), magnetoresistive RAM (MRAM) and/or phase-change memory.

Each of apparatus 910 and apparatus 920 may be a communication entity capable of communicating with each other using various proposed schemes in accordance with the present disclosure. For illustrative purposes and without limitation, a description of capabilities of apparatus 910, as a target UE, and apparatus 920, as an anchor UE/positioning server UE, is provided below in the context of example processes 1000 and 1100. It is noteworthy that, although a detailed description of capabilities, functionalities and/or technical features of one of apparatus 910 and apparatus 920 is provided below, the same may be applied to the other of apparatus 910 and apparatus 920 although a detailed description thereof is not provided solely in the interest of brevity. It is also noteworthy that, although the example implementations described below are provided in the context of sidelink communications in a mobile network, the same may be implemented in other types of networks.

### Illustrative Processes

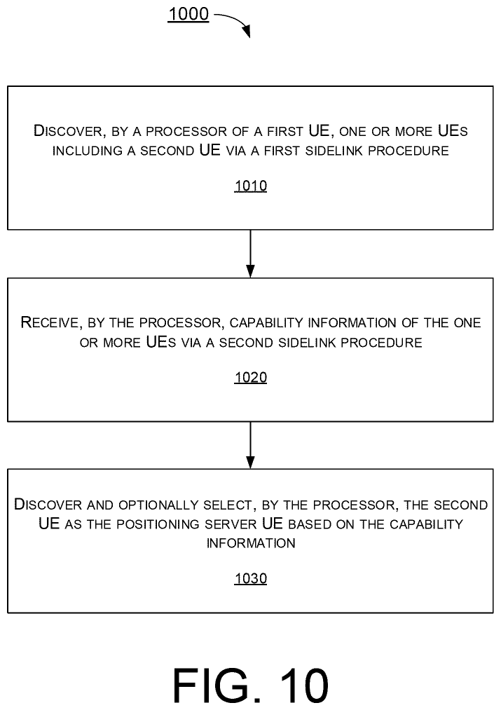

FIG. 10 illustrates an example process 1000 in accordance with an implementation of the present disclosure. Process 1000 may represent an aspect of implementing various proposed designs, concepts, schemes, systems and methods described above. More specifically, process 1000 may represent an aspect of the proposed concepts and schemes pertaining to an integrated procedure for UE capability exposure and positioning server UE selection in sidelink communications in accordance with the present disclosure. Process 1000 may include one or more operations, actions, or functions as illustrated by one or more of blocks 1010, 1020 and 1030. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively, in a different order. Furthermore, one or more of the blocks/sub-blocks of process 1000 may be executed repeatedly or iteratively. Process 1000 may be implemented by or in apparatus 910 and apparatus 920 as well as any variations thereof. Solely for illustrative purposes and without limiting the scope, process 1000 is described below in the context of apparatus 910 implemented in or as a target UE and apparatus 920 implemented in or as a positioning server UE of a wireless network such as a mobile network in accordance with one or more of 3GPP standards. Process 1000 may begin at block 1010.

At 1010, process 1000 may involve processor 912 of apparatus 910 discovering, via transceiver 916, one or more UEs, including apparatus 920, via a first sidelink procedure (e.g., by performing a discovery procedure). Process 1000 may proceed from 1010 to 1020.

At 1020, process 1000 may involve processor 912 receiving, via transceiver 916, capability information of the one or more UEs via a second sidelink procedure (e.g., by performing a capability exchange procedure to receive sidelink positioning capability information of each of the one or more UEs, including that of apparatus 920). Process 1000 may proceed from 1020 to 1030.

At 1030, process 1000 may involve processor 912 discovering and, optionally, selecting apparatus 920 as the positioning server UE based on the capability information.

In some implementations, process 1000 may further involve processor 912 sending, via transceiver 916, a selection message to apparatus 920 indicating selection of apparatus 920 by apparatus 910 as the positioning server UE. In some implementations, the selection message may also include an indication of at least one candidate anchor UE.

In some implementations, process 1000 may further involve processor 912 receiving, via transceiver 916, a confirmation message from apparatus 920 indicating that apparatus 920 accepts the selection by apparatus 910 of apparatus 920 as the positioning server UE.

In some implementations, process 1000 may further involve processor 912 receiving, via transceiver 916, a request from apparatus 920 for capability information (e.g., sidelink positioning capability information) of apparatus 910. Accordingly, process 1000 may further involve processor 912 sending, via transceiver 916, a capability information message to apparatus 920 indicating capabilities of apparatus 910 (e.g., sidelink positioning capability of apparatus 910).

In some implementations, process 1000 may further involve processor 912 receiving, via transceiver 916, a capability request message from apparatus 920 requesting for capability information of apparatus 910. Moreover, process 1000 may involve processor 912 sending, via transceiver 916, a capability information message to apparatus 920 indicating capabilities of apparatus 910 (e.g., sidelink positioning capability of apparatus 910).

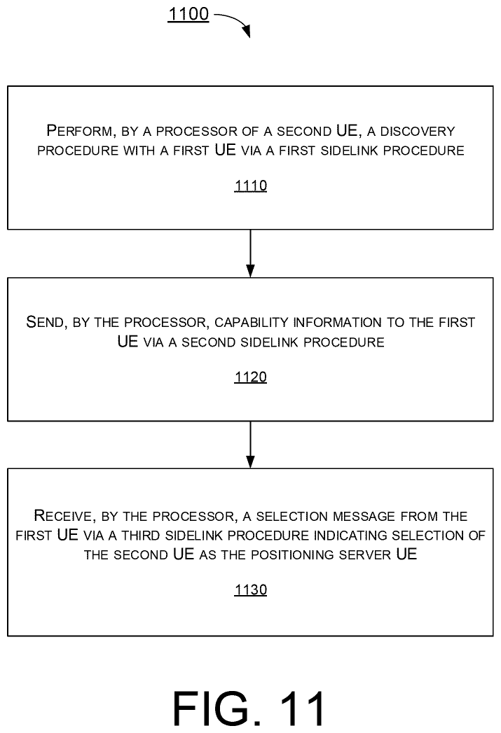

FIG. 11 illustrates an example process 1100 in accordance with an implementation of the present disclosure. Process 1100 may represent an aspect of implementing various proposed designs, concepts, schemes, systems and methods described above. More specifically, process 1100 may represent an aspect of the proposed concepts and schemes pertaining to an integrated procedure for UE capability exposure and positioning server UE selection in sidelink communications in accordance with the present disclosure. Process 1100 may include one or more operations, actions, or functions as illustrated by one or more of blocks 1110, 1120 and 1130. Although illustrated as discrete blocks, various blocks of process 1100 may be divided into additional blocks, combined into fewer blocks, or eliminated, depending on the desired implementation. Moreover, the blocks/sub-blocks of process 1100 may be executed in the order shown in FIG. 11 or, alternatively, in a different order. Furthermore, one or more of the blocks/sub-blocks of process 1100 may be executed repeatedly or iteratively. Process 1100 may be implemented by or in apparatus 910 and apparatus 920 as well as any variations thereof. Solely for illustrative purposes and without limiting the scope, process 1100 is described below in the context of apparatus 910 implemented in or as a target UE and apparatus 920 implemented in or as a positioning server UE of a wireless network such as a mobile network in accordance with one or more of 3GPP standards. Process 1100 may begin at block 1110.

At 1110, process 1000 may involve processor 922 of apparatus 920 performing, via transceiver 926, a discovery procedure with apparatus 910 (e.g., by performing a discovery procedure). Process 1100 may proceed from 1110 to 1120.

At 1120, process 1100 may involve processor 922 sending, via transceiver 926, capability information to apparatus 910 via a second sidelink procedure (e.g., by performing a capability exchange procedure to provide sidelink positioning capability information of apparatus 920 to apparatus 910). Process 1100 may proceed from 1120 to 1130.

At 1130, process 1100 may involve processor 922 receiving, via transceiver 926, a selection message from apparatus 910 via a third sidelink procedure indicating selection of apparatus 920 as the positioning server UE.

In some implementations, the selection message may further include an indication of at least one candidate anchor UE. Accordingly, process 1100 may further involve processor 922 receiving, via transceiver 926, capability information (e.g., sidelink positioning capability information) of the at least one candidate anchor UE.

In some implementations, process 1100 may further involve processor 922 performing, via transceiver 926, a sidelink positioning procedure with apparatus 910.

In some implementations, process 1100 may further involve processor 922 sending, via transceiver 926, a confirmation message to apparatus 910 indicating that apparatus 920 accepts the selection by apparatus 910 of apparatus 920 as the positioning server UE. In some implementations, the confirmation message may also include a request for capability information of apparatus 910.

In some implementations, process 1100 may further involve processor 922 receiving, via transceiver 926, a capability information message from apparatus 910 indicating capabilities of apparatus 910.

In some implementations, process 1100 may further involve processor 922 sending, via transceiver 926, a capability request message to apparatus 910 requesting for capability information of apparatus 910. Moreover, process 1100 may involve processor 922 receiving, via transceiver 926, a capability information message from apparatus 910 indicating capabilities of apparatus 910.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method of a first user equipment (UE), as a target UE, selecting a second UE as a positioning server UE, comprising:
discovering, by a processor of the first UE, one or more UEs including the second UE via one or more sidelink procedures;
receiving, by the processor, capability information of the one or more UEs via the one or more sidelink procedures; and
selecting, by the processor, the second UE from the one or more sidelink procedures as the positioning server UE based on the capability information.

2. The method of claim 1, further comprising:
sending, by the processor, a selection message to the second UE indicating selection of the second UE by the first UE as the positioning server UE.

3. The method of claim 2, wherein the selection message further comprises an indication of at least one candidate anchor UE.

4. The method of claim 2, further comprising:
receiving, by the processor, a confirmation message from the second UE indicating that the second UE accepts the selection by the first UE of the second UE as the positioning server UE.

5. The method of claim 2, further comprising:
receiving, by the processor, a request from the second UE for sidelink positioning capability information of the first UE.

6. The method of claim 5, further comprising:
sending, by the processor, a capability information message to the second UE indicating capabilities of the first UE.

7. The method of claim 2, further comprising:
receiving, by the processor, a capability request message from the second UE requesting capability information of the first UE.

8. The method of claim 7, further comprising:
sending, by the processor, a capability information message to the second UE indicating capabilities of the first UE.

9. A method of a second user equipment (UE), as a positioning server UE, operating with a first UE as a target UE, comprising:
performing, by a processor of the second UE, a discovery procedure with the first UE via one or more sidelink procedures;
sending, by the processor, capability information to the first UE via the one or more sidelink procedures; and
receiving, by the processor, a selection message from the first UE via the one or more sidelink procedures indicating selection of the second UE as the positioning server UE.

10. The method of claim 9, wherein the selection message further comprises an indication of at least one candidate anchor UE.

11. The method of claim 10, further comprising:
receiving, by the processor, sidelink positioning capability information of the at least one candidate anchor UE.

12. The method of claim 9, further comprising:
performing, by the processor, a sidelink positioning procedure with the first UE.

13. The method of claim 9, further comprising:
sending, by the processor, a confirmation message to the first UE indicating that the second UE accepts the selection by the first UE of the second UE as the positioning server UE.

14. The method of claim 13, wherein the confirmation message further comprises a request for capability information of the first UE.

15. The method of claim 9, further comprising:
receiving, by the processor, a capability information message from the first UE indicating capabilities of the first UE.

16. The method of claim 9, further comprising:
sending, by the processor, a capability request message to the first UE requesting for capability information of the first UE.

17. The method of claim 16, further comprising:
receiving, by the processor, a capability information message from the first UE indicating capabilities of the first UE.

18. An apparatus implementable in a first user equipment (UE), comprising:
a transceiver configured to communicate wirelessly; and
a processor coupled to the transceiver and configured to perform operations comprising:
discovering, via the transceiver, one or more UEs via one or more sidelink procedures;
receiving, via the transceiver, capability information of the one or more UEs via the one or more sidelink procedures; and
selecting the second UE as a positioning server UE based on the capability information.

19. The apparatus of claim 18, wherein the processor is further configured to perform operations comprising:
sending, via the transceiver, a selection message to the second UE indicating selection of the second UE by the first UE as the positioning server UE.

20. The apparatus of claim 19, wherein the selection message further comprises an indication of at least one candidate anchor UE.
